(19) United States
(12) Patent Application Publication
(10) Pub. No.: US 2025/0334339 A1
(43) Pub. Date: Oct. 30, 2025

(54) ADDITIVELY MANUFACTURED HEAT EXCHANGER

(71) Applicant: Hamilton Sundstrand Corporation, Charlotte, NC (US)

(72) Inventor: Evan J. Butcher, Suffield, CT (US)

(21) Appl. No.: 18/651,078

(22) Filed: Apr. 30, 2024

(51) Int. Cl. F28D 7/00; F28F 7/02; F28F 9/02

(52) U.S. Cl. CPC F28D 7/0025; F28F 7/02; F28F 2009/0287; F28F 2225/08

(57) ABSTRACT

An additively manufactured heat exchanger is provided and includes first and second inlet headers which are interlaced with one another, first and second outlet headers which are interlaced with one another and a core. The core is interposed between a pair of the first and second inlet headers and a pair of the first and second outlet headers. The core includes first pathways by which a first fluid flows from the first inlet header to the first outlet header and second pathways disposed in thermal communication with the first pathways and by which a second fluid flows from the second inlet header to the second outlet header.

### STATEMENT OF FEDERAL SUPPORT

This invention was made with government support under Government Contract No. 80JSC022DA023 awarded by NASA. The government has certain rights in the invention.

### BACKGROUND

The present disclosure relates to heat exchangers and, in particular, to additively manufactured heat exchangers with various designs and features.

A heat exchanger is a component of various types of systems in which heat is removed from a first fluid and transferred to a second fluid. In an exemplary case, a heat exchanger can be used in an aircraft engine for cooling or heating fuel or oil using a flow of relatively cold air or another fluid. In these or other cases, fuel flows into the heat exchanger via a fuel inlet manifold and is directed to fuel pathways extending between the fuel inlet manifold and a fuel outlet manifold. The fuel flows along the fuel pathways and into the fuel outlet manifold and subsequently leaves the heat exchanger. At the same time, oil flows into the heat exchanger via an oil inlet manifold and is directed to oil pathways extending between the oil inlet manifold and an oil outlet manifold. The oil flows along the oil pathways and into the oil outlet manifold and subsequently leaves the heat exchanger. The fuel pathways and the oil pathways can be adjacent to one another. As the fuel and oil flow along the fuel and oil pathways, respectively, heat is transferred from the hotter fluid to the colder fluid through a material of the fuel and oil pathways. This heat transfer can be increased by various methods including, but not limited to, increasing a surface area for heat transfer by adding fins to the fuel and oil pathways and/or by extending the fuel and oil pathways.

### SUMMARY

According to an aspect of the disclosure, an additively manufactured heat exchanger is provided and includes first and second inlet headers which are interlaced with one another, first and second outlet headers which are interlaced with one another and a core. The core is interposed between a pair of the first and second inlet headers and a pair of the first and second outlet headers. The core includes first pathways by which a first fluid flows from the first inlet header to the first outlet header and second pathways disposed in thermal communication with the first pathways and by which a second fluid flows from the second inlet header to the second outlet header.

In accordance with additional or alternative embodiments, the first and second pathways are each arranged in rows and columns of first and second individual pathways, respectively, and the rows and the columns of the first individual pathways are respectively interlaced with the rows and the columns of the second individual pathways.

In accordance with additional or alternative embodiments, the first inlet and outlet headers each include a header component, a body connected to the header component and header fins arrayed along and extending from the body for association with each column of the first individual pathways and the second inlet and outlet headers each include a header component, a body connected to the header component and header fins arrayed along and extending from the body for association with each column of the first individual pathways.

In accordance with additional or alternative embodiments, the body and the header fins of the second inlet header cooperatively encompass at least a portion of the body and the header fins of the first inlet header and the body and the header fins of the second outlet header cooperatively encompass at least a portion of the body and the header fins of the first outlet header.

In accordance with additional or alternative embodiments, the bodies of the first inlet and outlet headers and the bodies of the second inlet and outlet headers have rounded exteriors and extend across a width of an upper portion of the core and the header fins of the first inlet and outlet headers and the header fins of the second inlet and outlet headers have C-shaped cross-sections and extend downwardly from the corresponding body along a height of a corresponding side of the core.

In accordance with additional or alternative embodiments, the first inlet and outlet headers each further include stiffening fins arrayed between neighboring ones of the header fins and the second inlet and outlet headers each further include stiffening fins arrayed between neighboring ones of the header fins, the stiffening fins including beams perpendicularly oriented relative to the corresponding header fins.

In accordance with additional or alternative embodiments, exterior structural reinforcements surround the first and second inlet headers, the first and second outlet headers and the core, the exterior structural reinforcements having one of a triangular pattern, a rectangular pattern and a hexagonal pattern.

In accordance with additional or alternative embodiments, the core further includes self-supporting core support structures.

According to an aspect of the disclosure, an additively manufactured heat exchanger is provided and includes first and second inlet headers which are interlaced with one another, first and second outlet headers which are interlaced with one another and a core. The core is interposed between a pair of the first inlet header and the second outlet header and a pair of the second inlet header and the first outlet header. The core includes first pathways by which a first fluid flows from the first inlet header to the first outlet header and second pathways disposed in thermal communication with the first pathways and by which a second fluid flows from the second inlet header to the second outlet header.

In accordance with additional or alternative embodiments, the first and second pathways are each arranged in rows and columns of first and second individual pathways, respectively, and the rows and the columns of the first individual pathways are respectively interlaced with the rows and the columns of the second individual pathways.

In accordance with additional or alternative embodiments, the first inlet and outlet headers each include a header component, a body connected to the header component and header fins arrayed along and extending from the body for association with each column of the first individual pathways and the second inlet and outlet headers each include a header component, a body connected to the header component and header fins arrayed along and extending from the body for association with each column of the first individual pathways.

In accordance with additional or alternative embodiments, the body and the header fins of the second outlet header cooperatively encompass at least a portion of the body and the header fins of the first inlet header and the body and the header fins of the second inlet header cooperatively encompass at least a portion of the body and the header fins of the first outlet header.

In accordance with additional or alternative embodiments, the bodies of the first inlet and outlet headers and the bodies of the second inlet and outlet headers have rounded exteriors and extend across a width of an upper portion of the core and the header fins of the first inlet and outlet headers and the header fins of the second inlet and outlet headers have C-shaped cross sections and extend downwardly from the corresponding body along a height of a corresponding side of the core.

In accordance with additional or alternative embodiments, the first inlet and outlet headers each further include stiffening fins arrayed between neighboring ones of the header fins and the second inlet and outlet headers each further include stiffening fins arrayed between neighboring ones of the header fins, the stiffening fins including beams perpendicularly oriented relative to the corresponding header fins.

In accordance with additional or alternative embodiments, exterior structural reinforcements surround the first and second inlet headers, the first and second outlet headers and the core, the exterior structural reinforcements having one of a triangular pattern, a rectangular pattern and a hexagonal pattern.

In accordance with additional or alternative embodiments, the core further includes self-supporting core support structures.

According to an aspect of the disclosure, a method of additively manufacturing a heat exchanger is provided. The method includes coincidental operations of building up layers of first and second inlet headers to be interlaced with one another by laser powder bed fusion (PBF-L), building up layers of first and second outlet headers to be interlaced with one another by PBF-L and building up layers of a core interposed between a pair of the first and second inlet headers and a pair of the first and second outlet headers by PBF-L such that the core includes first pathways by which a first fluid flows from the first inlet header to the first outlet header and second pathways disposed in thermal communication with the first pathways and by which a second fluid flows from the second inlet header to the second outlet header.

In accordance with additional or alternative embodiments, the coincidental operations of the building up of the layers of the first and second inlet headers and the building up of the layers of the first and second outlet headers include building up layers of stiffening fins to be arrayed between neighboring header fins of the first and second inlet headers and the first and second outlet headers by PBF-L.

In accordance with additional or alternative embodiments, the method further includes a coincidental operation of building up layers of exterior structural reinforcements to surround corresponding layers of the first and second inlet headers, the first and second outlet headers and the core by PBF-L.

In accordance with additional or alternative embodiments, the coincidental operations of the building up of the layers of the core include building up layers of self-supporting core support structures by PBF-L.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIG. 1 is a perspective view of an additively manufactured heat exchanger in accordance with embodiments;

FIG. 2 is a top-down view of the additively manufactured heat exchanger of FIG. 1 in accordance with embodiments;

FIG. 3A is an enlarged top-down cross-sectional view of a first portion of the additively manufactured heat exchanger of FIG. 1 in accordance with embodiments;

FIG. 3B is an enlarged top-down cross-sectional view of a second portion of the additively manufactured heat exchanger of FIG. 1 in accordance with embodiments;

FIG. 4 is a schematic illustration of a cross-sectional shape of header fins of the additively manufactured heat exchanger of FIG. 1 in accordance with embodiments;

FIG. 5 is a cross-sectional view of first and second flowpaths of the additively manufactured heat exchanger of FIG. 1 in accordance with embodiments;

FIG. 6 is a schematic side view of header fin stiffeners of the additively manufactured heat exchanger of FIG. 1 in accordance with embodiments;

FIG. 7 is a schematic side view of exterior structural reinforcements of the additively manufactured heat exchanger of FIG. 1 in accordance with embodiments;

FIG. 8 is a schematic side view of self-supporting core support features of the additively manufactured heat exchanger of FIG. 1 in accordance with embodiments; and

FIG. 9 is a flow diagram illustrating a method of additively manufacturing a heat exchanger in accordance with embodiments.

### DETAILED DESCRIPTION

Many technological fields, including aerospace, are interested in advanced heat exchangers as operating temperatures increase and as cooling requirements also increase. It has been found, however, that advanced heat exchangers are difficult to manufacture using conventional processes, such as casting and machining. This is due to the fact that advanced heat exchangers can have complex internal geometries. As a consequence, heat exchangers are often manufactured with sub-optimal designs for manufacturability.

Recently, manufacturability of advanced heat exchangers has been improved using additive manufacturing techniques, such as laser powder bed fusion (PBF-L). Thus, as will be described below, an additively manufactured heat exchanger is provided and includes several non-conventional features. These include, but are not limited to, interlaced hot and cold header geometries, localized interior and exterior stiffeners and self-supporting geometries.

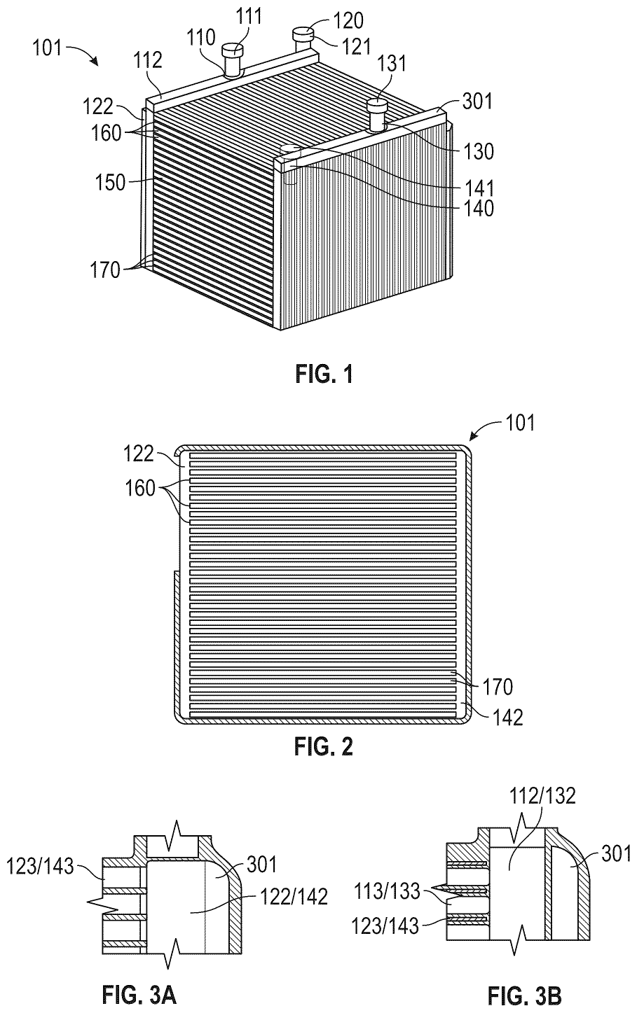

With reference to FIGS. 1-5, an additively manufactured heat exchanger 101 is provided and includes a first inlet header 110, a second inlet header 120, a first outlet header 130, a second outlet header 140 and a core 150. The first and second inlet headers 110 and 120 are provided on a same side of the core 150 and are interlaced with one another in a 1:1 relationship. The first and second outlet headers 130 and 140 are provided on a same side of the core 150 and are interlaced with one another in a 1:1 relationship. The core 150 is interposed between a pair of the first and second inlet headers 110 and 120 and a pair of the first and second outlet headers 130 and 140 and includes first pathways 160 and second pathways 170. The first pathways 160 are configured for directing a first fluid (i.e., fuel, oil, water, air or other gas, etc.) to flow from the first inlet header 110 to the first outlet header 130. The second pathways 170 are configured for directing a second fluid (i.e., fuel, oil, water, air or other gas, etc.) to flow from the second inlet header 120 to the second outlet header 140. The first and second pathways 160 and 170 are disposed in thermal communication with one another such that, as the first fluid flows along the first pathways 160 and the second fluid flows along the second pathways 170, heat is transferred from the hotter fluid to the colder fluid.

As shown in FIG. 5, the first pathways 160 are arranged in rows of individual pathways 161 and in columns of first individual pathways 162 and the second pathways 170 are arranged in rows of second individual pathways 171 and columns of second individual pathways 172. The rows and the columns of the first individual pathways 161 and 162 are respectively interlaced with the rows and the columns of the second individual pathways 171 and 172.

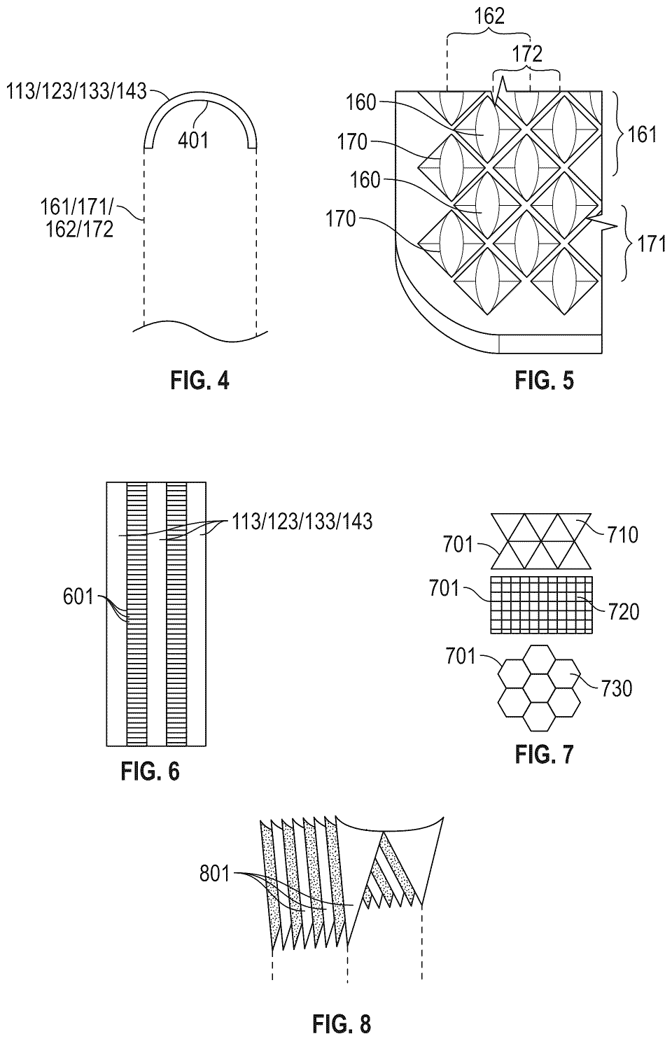

The first inlet header 110 includes a header component 111, a body 112 to which the header component 111 is connected and header fins 113. The body 112 is an elongate volumetric body with a rounded exterior 301 (see FIG. 1) and extends lengthwise across a width of an upper portion of the core 150. The header fins 113 can each have a C-shaped cross section 401 (see FIG. 4) that is open toward the first pathways 160. The header fins 113 are arrayed along and extend downwardly from the body 112 along a height of a corresponding side of the core 150 for association with each corresponding column of the first individual pathways 161.

The second inlet header 120 includes a header component 121, a body 122 to which the header component 121 is connected and header fins 123. The body 122 is an elongate volumetric body with a rounded exterior 301 (see FIGS. 3A and 3B) and extends lengthwise across a width of an upper portion of the core 150. The header fins 123 can each have a C-shaped cross section 401 (see FIG. 4) that is open toward the second pathways 170. The header fins 123 are arrayed along and extend downwardly from the body 122 along a height of a corresponding side of the core 150 for association with each corresponding column of the first individual pathways 171.

The first outlet header 130 includes a header component 131, a body 132 to which the header component 131 is connected and header fins 133. The body 132 is an elongate volumetric body with a rounded exterior 301 (see FIG. 1) and extends lengthwise across a width of an upper portion of the core 150. The header fins 133 can each have a C-shaped cross section 401 (see FIG. 4) that is open toward the first pathways 160. The header fins 133 are arrayed along and extend downwardly from the body 132 along a height of a corresponding side of the core 150 for association with each corresponding column of the first individual pathways 161.

The second outlet header 140 includes a header component 141, a body 142 to which the header component 141 is connected and header fins 143. The body 142 is an elongate volumetric body with a rounded exterior 301 (see FIGS. 3A and 3B) and extends lengthwise across a width of an upper portion of the core 150. The header fins 143 can each have a C-shaped cross section 401 (see FIG. 4) that is open toward the second pathways 170. The header fins 143 are arrayed along and extend downwardly from the body 142 along a height of a corresponding side of the core 150 for association with each corresponding column of the second individual pathways 171.

As shown in FIG. 2 and FIG. 3B, the body 122 and the header fins 123 of the second inlet header 120 can cooperatively encompass at least a portion of the body 112 and the header fins 113 of the first inlet header 110 and the body 142 and the header fins 143 of the second outlet header 140 can cooperatively encompass at least a portion of the body 132 and the header fins 133 of the first outlet header 130.

With reference to FIG. 6, the first inlet and outlet headers 110 and 130 and the second inlet and outlet header 120 and 140 can each further include stiffening fins 601. The stiffening fins 601 can be provided as beams arrayed between neighboring ones of the corresponding header fins 113, 123, 133 and 143. Each stiffening fin 601 can be oriented perpendicularly, for example, relative to the neighboring ones of the corresponding header fins 113, 123, 133 and 143. With the stiffening fins 601 provided as described herein, dimensions, weights and material properties of the neighboring ones of the corresponding header fins 113, 123, 133 and 143 can be adjusted (i.e., longer and wider header fins can be used). In some cases, the stiffening fins 601 can have a compliant geometry (i.e., a curved or spring-like geometry) that allows for increased flexure for conditions such as conflicts between high-cycle fatigue (HCF) and low-cycle fatigue (LCF).

With reference to FIG. 7, the additively manufactured heat exchanger 101 can further include exterior structural reinforcements 701 surrounding the first and second inlet headers 110 and 120, the first and second outlet headers 130 and 140 and the core 150. As shown in FIG. 7, the exterior structural reinforcements 701 can have one or more of a triangular pattern 710, a rectangular pattern 720 and a hexagonal pattern 730. Field-driven modeling may be leveraged to tune sizing and spacing of the exterior structural reinforcements 701 using a stress field or other response derived from engineering analyses.

With reference to FIG. 8, the core 150 can further include self-supporting core support structures 801. The self-supporting core support structures 801 may be leveraged to mitigate significant downskin surface area. For counter-flow or cross-flow configurations, the self-supporting core support structures 801 may be provided as gussets that can align with flow directions. The self-supporting core support structures 801 can provide for increased heat transfer surface area, reduced stress and increased self-supporting geometric areas for additive manufacturing.

With continued reference to FIGS. 1-8, it is noted that the additively manufactured heat exchanger 101 has been described with a configuration in which the first and second inlet headers 110 and 120 are provided on a same side of the core 150 and the first and second outlet headers 130 and 140 are provided on a same side of the core 150. It is to be understood that this is not required, however, and that other embodiments are possible. For example, the core 150 can be interposed between a pair of the first inlet header 110 and the second outlet header 140 and a pair of the second inlet header 120 and the first outlet header 130. In these or other cases, the first and second inlet headers 110 and 120 are on opposite sides of the core 150 and the first and second outlet headers 130 and 140 are on opposite sides of the core 150. It will be evident to a person of ordinary skill in the art how to build and practice these alternative configurations without undue experimentation and thus a detailed description is not needed beyond the described provided herein.

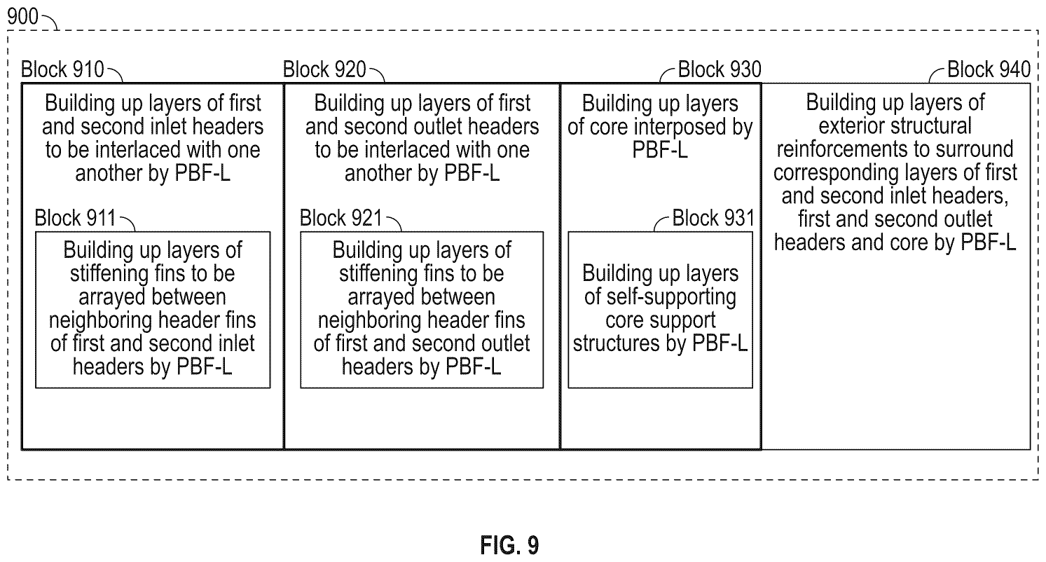

With reference to FIG. 9, a method 9000 of additively manufacturing a heat exchanger, such as the heat exchanger 101 described above, is provided. The method 900 includes coincidental operations of building up layers of first and second inlet headers to be interlaced with one another by laser powder bed fusion (PBF-L) (block 910), building up layers of first and second outlet headers to be interlaced with one another by PBF-L (block 920) and building up layers of a core interposed between a pair of the first and second inlet headers and a pair of the first and second outlet headers by PBF-L (block 930) such that the core includes the first and second pathways as described above.

The coincidental operations of the building up of the layers of the first and second inlet headers of block 910 and the building up of the layers of the first and second outlet headers of block 920 can further include building up layers of stiffening fins to be arrayed between neighboring header fins of the first and second inlet headers and the first and second outlet headers by PBF-L (block 911 and block 921, respectively). In addition, the method 900 can include a coincidental operation of building up layers of exterior structural reinforcements to surround corresponding layers of the first and second inlet headers, the first and second outlet headers and the core by PBF-L (block 940). Also, the coincidental operations of the building up of the layers of the core of block 930 can include building up layers of self-supporting core support structures by PBF-L (block 931).

As used herein, the coincidental operations of layer build-up refers to the fact that, as each layer of the additively manufactured heat exchanger (i.e., the additively manufactured heat exchanger 101 described above) is laid down, that layer can include a corresponding portion of one or more of the first and second inlet and outlet headers, the core, the stiffening fins, the exterior structural reinforcements and the self-supporting core support structures. In this manner, additive manufacturing can provide for the build-up of complex structural geometries that are not otherwise possible with conventional processes, such as casting and machining.

Technical effects and benefits of the present disclosure are the provision of an additively manufactured heat exchanger including several non-conventional features. These include, but are not limited to, interlaced hot and cold headers which allow for additional heat transfer outside the core, internal fin stiffeners that are advantageous in that they contribute to avoiding manufacturing challenges like buckling and also increase primary surface areas for heat transfer, exterior structural reinforcing structures which allow for thinner walls while maintaining structural margins and self-supporting geometries that enable additive manufacturing and reduced packaging envelopes.

The corresponding structures, materials, acts and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the technical concepts in the form disclosed. Many modifications and variations will be apparent to those of ordinary skill in the art without departing from the scope and spirit of the disclosure. The embodiments were chosen and described in order to best explain the principles of the disclosure and the practical application and to enable others of ordinary skill in the art to understand the disclosure for various embodiments with various modifications as are suited to the particular use contemplated.

While the preferred embodiments to the disclosure have been described, it will be understood that those skilled in the art, both now and in the future, may make various improvements and enhancements which fall within the scope of the claims which follow. These claims should be construed to maintain the proper protection for the disclosure first described.

What is claimed is:

1. An additively manufactured heat exchanger, comprising:
first and second inlet headers which are interlaced with one another;
first and second outlet headers which are interlaced with one another; and
a core interposed between a pair of the first and second inlet headers and a pair of the first and second outlet headers, the core comprising:
first pathways by which a first fluid flows from the first inlet header to the first outlet header; and
second pathways disposed in thermal communication with the first pathways and by which a second fluid flows from the second inlet header to the second outlet header.

2. The additively manufactured heat exchanger according to claim 1, wherein:
the first and second pathways are each arranged in rows and columns of first and second individual pathways, respectively, and
the rows and the columns of the first individual pathways are respectively interlaced with the rows and the columns of the second individual pathways.

3. The additively manufactured heat exchanger according to claim 2, wherein:
the first inlet and outlet headers each comprise a header component, a body connected to the header component and header fins arrayed along and extending from the body for association with each column of the first individual pathways, and
the second inlet and outlet headers each comprise a header component, a body connected to the header component and header fins arrayed along and extending from the body for association with each column of the first individual pathways.

4. The additively manufactured heat exchanger according to claim 3, wherein:
the body and the header fins of the second inlet header cooperatively encompass at least a portion of the body and the header fins of the first inlet header, and
the body and the header fins of the second outlet header cooperatively encompass at least a portion of the body and the header fins of the first outlet header.

5. The additively manufactured heat exchanger according to claim 3, wherein:
the bodies of the first inlet and outlet headers and the bodies of the second inlet and outlet headers have rounded exteriors and extend across a width of an upper portion of the core, and
the header fins of the first inlet and outlet headers and the header fins of the second inlet and outlet headers have C-shaped cross-sections and extend downwardly from the corresponding body along a height of a corresponding side of the core.

6. The additively manufactured heat exchanger according to claim 3, wherein:
the first inlet and outlet headers each further comprise stiffening fins arrayed between neighboring ones of the header fins, and
the second inlet and outlet headers each further comprise stiffening fins arrayed between neighboring ones of the header fins,
wherein the stiffening fins comprise beams perpendicularly oriented relative to the corresponding header fins.

7. The additively manufactured heat exchanger according to claim 1, further comprising exterior structural reinforcements surrounding the first and second inlet headers, the first and second outlet headers and the core,
wherein the exterior structural reinforcements have one of a triangular pattern, a rectangular pattern and a hexagonal pattern.

8. The additively manufactured heat exchanger according to claim 1, wherein the core further comprises self-supporting core support structures.

9. An additively manufactured heat exchanger, comprising:
first and second inlet headers which are interlaced with one another;
first and second outlet headers which are interlaced with one another; and
a core interposed between a pair of the first inlet header and the second outlet header and a pair of the second inlet header and the first outlet header, the core comprising:
first pathways by which a first fluid flows from the first inlet header to the first outlet header; and
second pathways disposed in thermal communication with the first pathways and by which a second fluid flows from the second inlet header to the second outlet header.

10. The additively manufactured heat exchanger according to claim 9, wherein:
the first and second pathways are each arranged in rows and columns of first and second individual pathways, respectively, and
the rows and the columns of the first individual pathways are respectively interlaced with the rows and the columns of the second individual pathways.

11. The additively manufactured heat exchanger according to claim 10, wherein:
the first inlet and outlet headers each comprise a header component, a body connected to the header component and header fins arrayed along and extending from the body for association with each column of the first individual pathways, and
the second inlet and outlet headers each comprise a header component, a body connected to the header component and header fins arrayed along and extending from the body for association with each column of the first individual pathways.

12. The additively manufactured heat exchanger according to claim 11, wherein:
the body and the header fins of the second outlet header cooperatively encompass at least a portion of the body and the header fins of the first inlet header, and
the body and the header fins of the second inlet header cooperatively encompass at least a portion of the body and the header fins of the first outlet header.

13. The additively manufactured heat exchanger according to claim 11, wherein:
the bodies of the first inlet and outlet headers and the bodies of the second inlet and outlet headers have rounded exteriors and extend across a width of an upper portion of the core, and
the header fins of the first inlet and outlet headers and the header fins of the second inlet and outlet headers have C-shaped cross sections and extend downwardly from the corresponding body along a height of a corresponding side of the core.

14. The additively manufactured heat exchanger according to claim 11, wherein:
the first inlet and outlet headers each further comprise stiffening fins arrayed between neighboring ones of the header fins, and
the second inlet and outlet headers each further comprise stiffening fins arrayed between neighboring ones of the header fins,
wherein the stiffening fins comprise beams perpendicularly oriented relative to the corresponding header fins.

15. The additively manufactured heat exchanger according to claim 9, further comprising exterior structural reinforcements surrounding the first and second inlet headers, the first and second outlet headers and the core,
wherein the exterior structural reinforcements have one of a triangular pattern, a rectangular pattern and a hexagonal pattern.

16. The additively manufactured heat exchanger according to claim 9, wherein the core further comprises self-supporting core support structures.

17. A method of additively manufacturing a heat exchanger, the method comprising coincidental operations of:
building up layers of first and second inlet headers to be interlaced with one another by laser powder bed fusion (PBF-L);
building up layers of first and second outlet headers to be interlaced with one another by PBF-L; and
building up layers of a core interposed between a pair of the first and second inlet headers and a pair of the first and second outlet headers by PBF-L such that the core comprises:
first pathways by which a first fluid flows from the first inlet header to the first outlet header; and
second pathways disposed in thermal communication with the first pathways and by which a second fluid flows from the second inlet header to the second outlet header.

18. The method according to claim 17, wherein the coincidental operations of the building up of the layers of the first and second inlet headers and the building up of the layers of the first and second outlet headers comprise building up layers of stiffening fins to be arrayed between neighboring header fins of the first and second inlet headers and the first and second outlet headers by PBF-L.

19. The method according to claim 17, further comprising a coincidental operation of building up layers of exterior structural reinforcements to surround corresponding layers of the first and second inlet headers, the first and second outlet headers and the core by PBF-L.

20. The method according to claim 17, wherein the coincidental operations of the building up of the layers of the core comprise building up layers of self-supporting core support structures by PBF-L.
